(19) United States
(12) Patent Application Publication
(10) Pub. No.: US 2011/0099549 A1
(43) Pub. Date: Apr. 28, 2011

(54) METHODS, SYSTEMS AND COMPUTER PROGRAM PRODUCTS FOR A REMINDER MANAGER FOR PROJECT DEVELOPMENT

(75) Inventors: Priyanka G. Sriraghavan, Chennai (IN); Lakshmi Nrusimhan N V, Channai (IN)

(73) Assignee: Verizon Patent and Licensing Inc., Basking Ridge, NJ (US)

(21) Appl. No.: 12/607,008

(22) Filed: Oct. 27, 2009

(51) Int. Cl. G06F 9/46

(52) U.S. Cl. 718/100

(57) ABSTRACT

This disclosure details the implementation of apparatuses, methods and systems of a reminder manager for project development (hereinafter, “R-Manager”). In one embodiment, a R-Manager system may implement a daemon application to monitor a plurality of code development entities, maintain a list of reminders and associated tasks and send reminders to users. In one embodiment, the R-Manager allows a user to directly write a reminder in a segment of source code, and then locate and add the embedded reminder to the system by automatically scanning the body of the source file. The R-Manager system can also enforce the completion of a task if the reminder of the task has expired and the task has not been marked as completed.

### BACKGROUND

In project development of a software application, the application may include a large portfolio of source files and each source file may contain thousands of lines of source code. Such development projects usually involve collaborations of a large number of developers, code reviewers, and team managers. Some Integrated Development Environments (IDEs) provide task management tools to monitor the progress of code development tasks. For example, the Eclipse IDE for Java development, the Visual FoxPro Task Pane Manager, and/or the like.

### BRIEF DESCRIPTION OF THE DRAWINGS

FIG. 1 provides an overview of an implementation of data flow between a reminder manager (hereinafter “R-MANAGER”) system and affiliated entities in one embodiment of R-MANAGER operation;

FIG. 2 shows an implementation of R-MANAGER system components in one embodiment of R-MANAGER operation;

FIG. 3 shows an overview of R-MANAGER logic flows for implementing a R-MANAGER application within one embodiment illustrating aspects of R-MANAGER operation;

FIGS. 4A-4C show aspects of logic flows for adding a new reminder and enforcing a task within embodiments of R-MANAGER operation; and

FIG. 5 provides an example of an implementation of a schematic user interface illustrating aspects of R-MANAGER operation in one embodiment;

FIG. 6 is of a block diagram illustrating exemplary embodiments of a R-MANAGER controller.

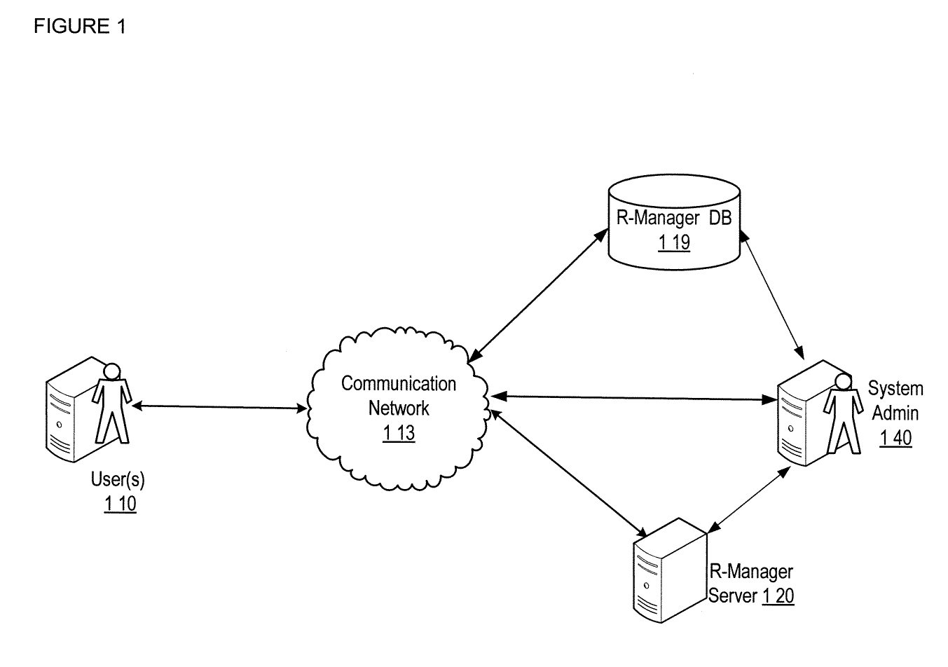

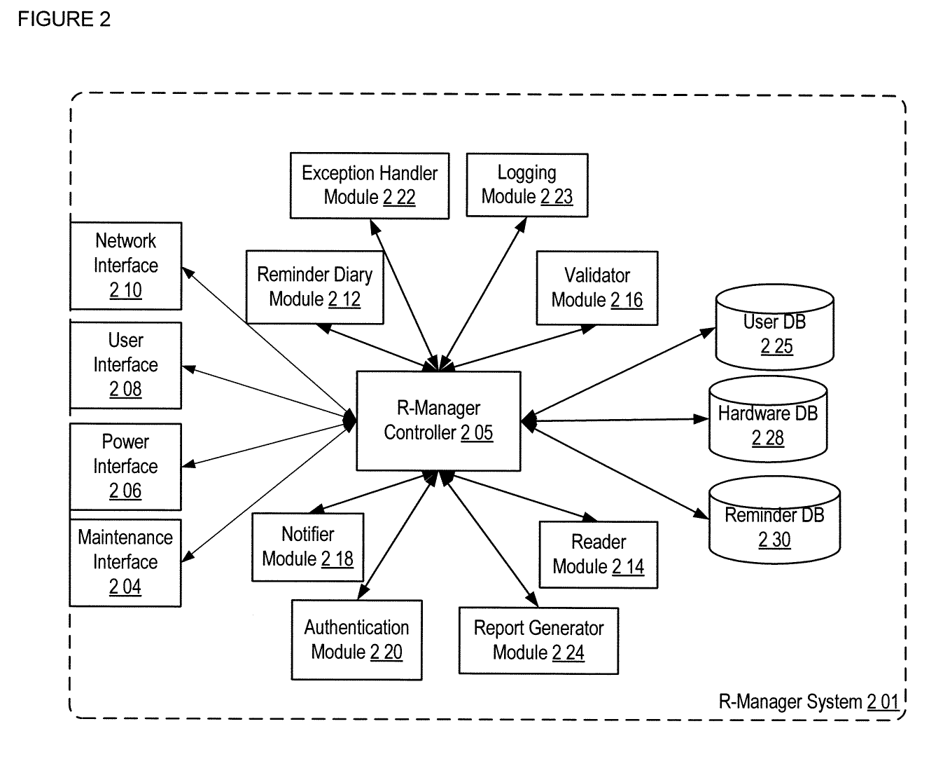

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

This disclosure details the implementation of apparatuses, methods and systems of a reminder manager for project development (hereinafter, “R-MANAGER”). R-MANAGER systems may, in one embodiment, implement a live daemon application on a computerized system, whereby the daemon application may receive, generate, store and send reminders to specific users in order to monitor the progress of the project development.

For example, in one embodiment, the R-MANAGER application may be installed and implemented with an Integrated Development Environment (IDE) for software development, such as, but not limited to Microsoft Visual Studio, Xcode, and/or the like. The R-MANAGER application may provide a graphical and/or command-line user interface for a user to add, delete and manage reminder(s) indicating a specific task, and the user may employ the R-MANAGER application through a variety of devices, such as terminal computers, work stations, servers, cellular telephony handsets, blackberries, PDAs, and/or the like. In particular, the user can directly write a reminder embedded in a source code file according to a predetermined syntax, and the R-MANAGER application may automatically scan the source code file and detect the embedded reminder. For instance, the following is one possible implementation of a reminder written in a segment of java code:

```
            ...
            /* TODO - Implement load balancing;
SD [12.05.2009:11h30m00s]; ED [22.05.2009: 15h00m00s];
FREQ [daily]; P1; USER [Joe Smith]; DEPENDENT FROM
[write setStickyBit(Node n) function]; */
            if (variable_value==0){
            ...
            ...}
```

The embedded reminder is written in compliance with a predetermined syntax. In one embodiment, the syntax may be a default setting of the R-MANAGER system. In one embodiment, the syntax may be determined and modified by an authorized user, e.g. a system administrator, and saved to the R-MANAGER configuration settings. In the above example, TODO indicates the pending task in the indicated segment of source code. SD implies the Start Date for the reminder to remind the user, e.g. a developer about the task. ED implies the End Date for the reminder to remind the user, i.e. the due date of the task. The granularity of Start Date and End Date of a reminder may be determined by the user. For example, in one implementation, the Start/End Dates of a reminder may be specified in days and/or hours, while in another implementation, the Start/End Dates may be specified in seconds. FREQ implies the frequency to remind the user about the task. P1 indicates the priority level of the task of the reminder, which can be assigned by the user when editing the reminder. In one implementation, the field of priority level may not have the filed name written in the tagged segment of code as determined by the syntax, for example, as shown in the above example, “P1” indicates the priority level. In one implementation, the priority level may be established and customized by the user in the configuration file of the R-MANAGER application, or may be a set of definite codes determined by the R-MANAGER application. USER indicates a user who adds the reminder. In one implementation, a user may also add names of other users to be reminded by the reminder under the USER field. In one implementation, a user may mandate a user name in the tagged segment of code in case he/she is not using a specific login, or the R-MANAGER is unable to automatically determine the user. In one implementation, When the R-MANAGER application has scanned and detected a reminder associated with a tagged segment of source code as illustrated in the example above, the R-MANAGER application may further extract the information, generate a reminder based on the extracted information, associate the reminder with a unique reminder ID and add the reminder to the repository of the application.

In one embodiment, the DEPENDENT FROM field in the reminder indicate the dependencies of the task among other tasks. In the above example, the reminder associated with “Implement Load Balancing” may only be implemented if another reminder associated with “Write setStickyBit(Node n) function” is marked as complete. In one embodiment, a reminder associated with “Implement load balancing” may be activated when at least one reminder associated with “Write setStickyBit(Node n) function” has reached the End Date. In one implementation, the DEPENDENT FROM field may refer to reminders relating to different code development entities. For example, in one implementation, reminders may be referred to with their unique IDs automatically assigned by the R-MANAGER for every reminder when it is added to the system.

In one embodiment, a user may pre-determine the minimum requirement as to which fields in the reminder syntax have to be specified in the system configuration of the R-MANAGER application. For example, in one implementation, a user may configure that at least the fields “TODO”, “SD” and “ED” need to be specified in order to be a valid reminder to be added to the repository. If an embedded reminder fails to contain the minimum requirement of information, the R-MANAGER may display an error message to indicate that essential information of the reminder is missing. In one embodiment, the reminder syntax may be configured such that the R-MANAGER may allow a user to write a reminder without the field names “SD”, “ED” etc. specified. For example, a reminder may be written in a form similar to the following:

/* TODO - Implement load balancing; [12.05.2009:11h30m00s];
[22.05.2009:15h00m00s]; [daily]; P1; [Joe Smith];
[write setStickyBit(Node n) function]; */

A task associated with a reminder may refer to one or more particular entities of a project. For example, in one embodiment, the task may refer to one or more of a source file, a directory of source files, the entirety of the project, and/or a group of files specified by a user submitted indication (e.g. all java files, all files created on a specific date, and/or the like), all of which are hereinafter referred to as a “code development entity”. In another embodiment, the task may also be related to a segment of code in a single source file, referred to as “tagged code”. As such, the reminder may be classified as a “for-entity” reminder and a “within-entity” reminder, which refers to a reminder relating to the entirety of a code development entity and a reminder relating to a specific tagged segment of code, respectively. For example, a reminder which requests a user to review an entire source code file is a for-entity reminder, while a reminder which requests a user to implement load balancing in a tagged segment of code is a within-entity reminder.

In one embodiment, R-MANAGER systems may plan and monitor tasks for projects in the future. For example, in one implementation, a reminder associated with a known task relating to a possible future project may be generated and marked as “scheduled for future” without specifying a time frame to send reminders. The reminder may be activated when the possible future project initiates, e.g. when a code file of the possible future project is checked in.

In one embodiment, a method is disclosed, comprising: receiving a request to add a new reminder of a task to a reminder list; associating at least one code development entity to the new reminder; adding the new reminder of the task associated with the at least one code development entity to the reminder list; presenting an existing reminder in the reminder list to at least one user; and enforcing at least one user to complete a task recorded by an existing reminder if the existing reminder of the task has expired. In one embodiment, the method further comprises: manually deleting an existing reminder from a reminder list; modifying an existing reminder in a reminder list; and marking a reminder as complete if the task has been accomplished or intentionally abandoned.

It is to be understood that, depending on the particular needs and/or characteristics of a R-MANAGER application, associated IDE, associated operating system, user interface, object, administrator, server, hardware configuration, network framework, and/or the like, various embodiments of the R-MANAGER may be implemented that enable a great deal of flexibility and customization. The instant disclosure discusses embodiments of the R-MANAGER primarily within the context of task management of software development. However, it is to be understood that the system described herein may be readily configured/customized for a wide range of other applications or implementations. For example, aspects of the R-MANAGER may be adapted for general project management, such as, but not limited to documentation management with multiple authors, and/or the like. It is to be understood that the R-MANAGER may be further adapted to other implementations or communications and/or data transmission applications, such as but not limited to multimedia systems, e.g. reminders may be recorded in a multimedia format, and/or the like.

FIG. 1 provides an overview of an implementation of data flow between a R-MANAGER system and affiliated entities in one embodiment of R-MANAGER operation. In FIG. 1, a user (or users) 110, a R-MANAGER server 120, a R-MANAGER database 119, and a system administrator 140 are shown to interact via a communication network 113. The user 110 may include a wide variety of different communications devices and technologies within embodiments of R-MANAGER operation. For example, in one embodiment, the users 110 may include, but are not limited to, terminal computers, work stations, servers, cellular telephony handsets, blackberries, PDAs, and/or the like. In one embodiment, the R-MANAGER server 120 may be equipped at a terminal computer of the user 110. In another embodiment, the R-MANAGER server 120 may be a remote server which is accessed by the user 110 via a communication network 113, such as, but not limited to local area network (LAN), in-house intranet, the Internet, and/or the like.

In one embodiment, the user 110 may generate and submit a reminder associated with a specific task and send it to the R-MANAGER server 120 through the communication network 113. In another embodiment, an application installed at the user 110 may automatically scan a group of code development entities for reminders embedded in tagged segments of code, and generate new reminders based on the scanned results. In one implementation, the user 110 may also submit configuration data to the R-MANAGER server 120 to establish and/or modify user-specific system settings, such as, but not limited to codes to indicate priority level of a reminder, syntax of reminders embedded in segments of source code, and/or the like. The R-MANAGER server 120 may send an existing reminder to the user 110 via the communication network 113, according to the configuration of the reminder. By way of example only, the R-MANAGER server 120 may display a message on the screen to the user 110, may send short messages to a cellular handset of the user 110, may send emails to the user 110, and/or the like.

In one embodiment, the R-MANAGER server 120 may also communicate with a R-MANAGER database 119. In some embodiments, a R-MANAGER server 120 may be integrated with a local R-MANAGER database 119. In other embodiments, a R-MANAGER server 120 may access a remote R-MANAGER database 119 via the communication network 113. The R-MANAGER server 120 may send the information to the database 119 for storage, such as, but not limited to user account information, new reminder details, new task details, and/or the like. The R-MANAGER database may also provide the R-MANAGER server 120 with information relating to existing reminders and tasks.

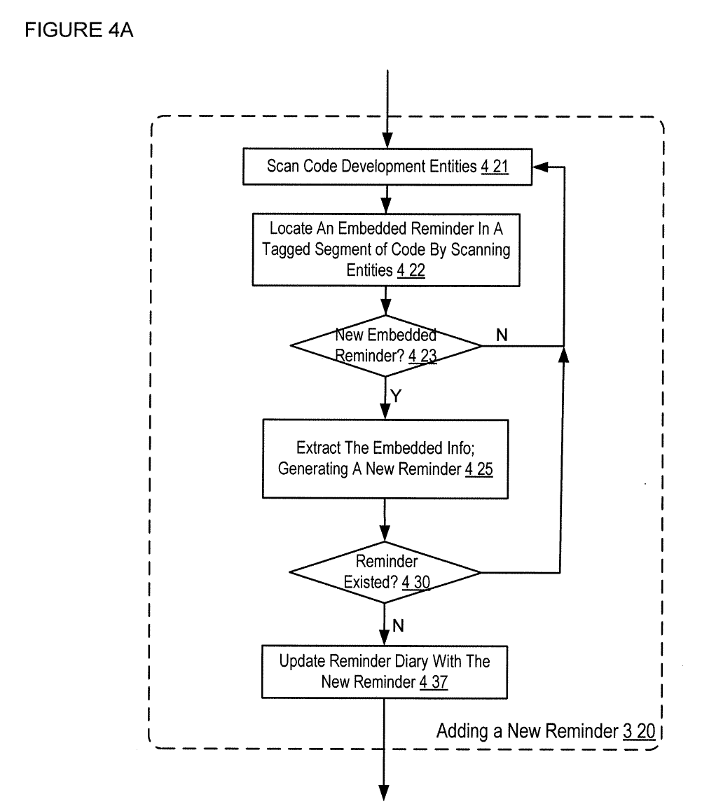

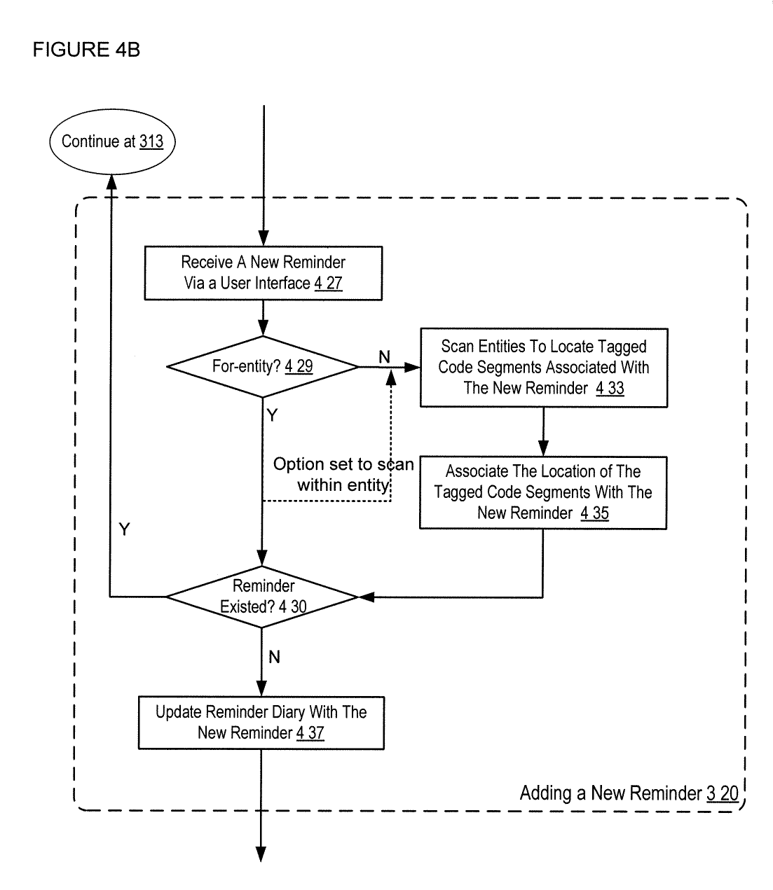

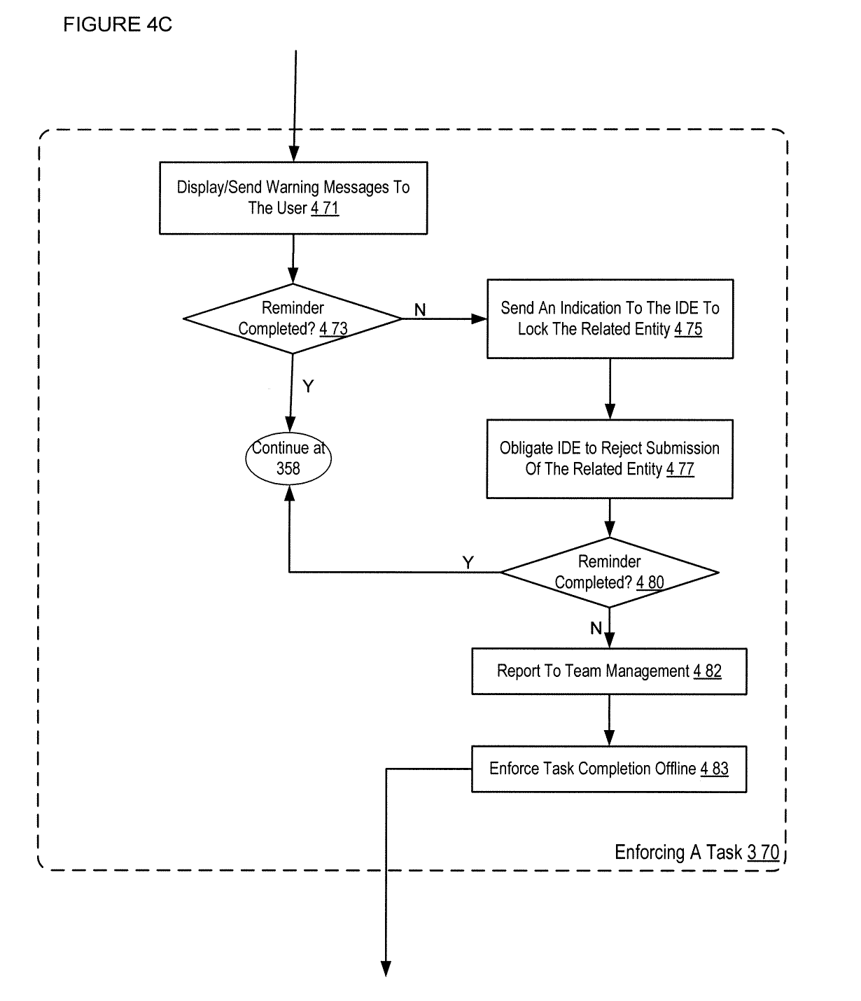

In one embodiment, a system administrator 140 may communicate with the R-MANAGER server 120 and the R-MANAGER database 119 for regular maintenance, service failure, system updates, database renewal, and/or the like. In one embodiment, the system administrator 140 may directly operate with the R-MANAGER server 120 and the R-MANAGER database 119 on an in-house basis, such as, but not limited to via an integrated administrator user interface. In another embodiment, the system administrator 140 may remotely access the R-MANAGER server 120 and the R-MANAGER database 119 and perform its functionality via the communication network 113. In one implementation, the system administrator 140 may configure the reminder syntax and save it to the R-MANAGER system. In one implementation, the system administrator 140 may be part of the team management of the ongoing project. In that case, as will be illustrated in FIG. 4C, the system administrator 140 may enforce a task completion offline (e.g. directly discuss the issue with the user) if a reminder associated with the task has already expired and warning messages have been sent to the user 110.

FIG. 2 shows an implementation of R-MANAGER system components in one embodiment of R-MANAGER operation. The R-MANAGER system 201 may contain a number of functional modules and/or data stores. A R-MANAGER controller 205 may serve a central role in some embodiments of R-MANAGER operation, serving to orchestrate the reception, generation, modification, and distribution of data and/or instructions, to, from, and between R-MANAGER modules and/or mediate communications with external entities and systems.

In one embodiment, the R-MANAGER controller 205 may be housed separately from other modules and/or databases within the R-MANAGER system, while in another embodiment, some or all of the other modules and/or databases may be housed within and/or configured as part of the R-MANAGER controller. Further detail regarding implementations of R-MANAGER controller operations, modules, and databases is provided below.

In the implementation illustrated in FIG. 2, the R-MANAGER controller 205 may be configured to couple to external entities via a maintenance interface 204, a power interface 206, a user interface 208 and a network interface 210. The user interface 208 may, for example, receive and configure reminders sent to/from the R-MANAGER, secured user account information, user submitted configuration data, and/or the like. In one implementation, the user interface 208 may include, but not limited to devices such as, keyboard(s), mouse, stylus(es), touch screen(s), digital display(s), and/or the like. In various implementations, the network interface 210 may, for example, serve to configure data into application, transport, network, media access control, and/or physical layer formats in accordance with a network transmission protocol, such as, but not limited to FTP, TCP/IP, SMTP, Short Message Peer-to-Peer (SMPP) and/or the like. For example, the network interface 210 may be configured for receipt and/or transmission of data to an external and/or network database. The network interface 210 may further be configurable to implement and/or translate Wireless Application Protocol (WAP), VoIP and/or the like data formats and/or protocols. The network interface 210 may further house one or more ports, jacks, antennas, and/or the like to facilitate wired and/or wireless communications with and/or within the R-MANAGER system. In one embodiment, the maintenance interface 204 may, for example, configure regular inspection and repairs, receive system upgrade data, report system behaviors, and/or the like. In one embodiment, the power interface 206 may, for example, connect the R-MANAGER system to an external power source.

In one implementation, the R-MANAGER controller 205 may further be coupled to a plurality of modules configured to implement R-MANAGER functionality and/or services. The plurality of modules may, in one embodiment, be configurable to implement a daemon application running in the background of an IDE of a software development project. Within embodiments, the daemon application may monitor all the code development entities of the current development project and scan the entities for reminders embedded in tagged segments of code, add and/or delete reminders to/from the system, send a reminder to a user, and/or the like. In one embodiment, the daemon application may comprise modules such as, but not limited to a Reminder Diary module 212, a Reader module 214, a Validator module 216, a Notifier module 218, a Authentication module 220, an Exception Handler module 222, a Logging module 223, a Report Generator Module 224, and/or the like.

In one embodiment, the Reminder Diary module 212 may reside in the memory of a computerized system or in a file system, and may also be registered with a group of code development entities. The Reminder Diary module 212 may maintain and/or operate with a list of existing reminders in chronological order. In one implementation, if the R-MANAGER is shut down, for example, the user has logged out the R-MANAGER system, the Reminder Diary module 212 may automatically record the time of system shutdown. When the R-MANAGER is initiated again, for example, at some point later the user logs into the system again, the Reminder Diary 212 may automatically calculate the elapsed time that the R-MANAGER is not active, and display/send all reminders which expired during the inactive time period. In one implementation, the Reminder Diary module 212 may receive new reminders from a user interface as a result of user interface action, for example, a user submitting a new reminder. The Reminder Diary module 212 may then add the received new reminder to a list of existing reminders, such as after the new reminder has been examined by the Validator module 216.

In one embodiment, the Validator module 216 may check the validity of a reminder. For example, in various implementations, the Validator module 216 may check whether a newly added reminder already exists in the system, whether a reminder conforms to the required syntax, whether a reminder is valid (for example, whether the expiration date of the reminder has already passed, whether the location of the related code development entity is valid, etc.), and/or the like.

In one embodiment, the Reader module 214 may constantly, periodically, and/or intermittently monitor and scan all code development entities registered in the R-MANAGER to detect any reminder embedded in a tagged segment of code and transmit any detected reminder to the Reminder Diary module 212. In one implementation, if a new reminder is directly submitted by a user through a user interface of the R-MANAGER but the reminder is related to a specific segment of code within a code development entity (for example, a source code file, etc.), the Reminder Diary module 212 may also request the Reader module 214 to scan the body of the code development entity to locate the related segment of code. In one embodiment, the Reminder Diary module 212 may also send requests to the Notifier 218 to present existing reminders to the related staff (e.g. staff who are recorded to be reminded about the task associated with a reminder) in different modes, such as, but not limited to displaying the reminder message on the screen, sending the reminder message via mobile terminated messages, emails, Internet chat platforms, and/or the like. In one embodiment, the Notifier module 218 may also automatically open a code development entity (e.g. a source code file) and highlight a embedded reminder and the associated tagged code lines to present the reminder to the user. In one implementation, the Notifier module 218 may allow a user to configure which application to open a code development file (e.g. Notepad, IDE environment, etc.). In one embodiment, the Notifier module 218 may also send warning messages to the related users for elapsed but not completed reminders.

In one embodiment, the Authentication module 220 may be configured to receive secured account information from a user via a user interface of the R-MANAGER, and grant the user or group access to the R-MANAGER if provided secured login information is correct. In one embodiment, users may configure group access to a plurality of reminders. For example, in one implementation, users working on “Project A” may register as a group with the R-MANAGER. Each member of the group may be granted access to read, write, modify and/or delete all reminders established by the group once logged in as a member of the group. In one embodiment, the Authentication module 220 may communicate with the users database to retrieve user profile information. In one implementation, the Authentication module 220 may also communicate with an IDE, an operating system, and/or the like, such that the R-MANAGER application may be automatically initiated when a user has logged into the IDE and/or the operating system. In an environment where multiple users may share the same code base, the Authentication module 220 may be configured to communicate with the Reminder Diary module 212 to subscribe a user to the Reminder Diary associated with a user account which may include reminders that are related to the user when the user has logged into the R-MANAGER.

The Exception Handler module 222 may interact with all other functional modules within one embodiment of R-MANAGER operation to handle errors and exceptions experienced by different components. By way of example only, exceptions may include, but not limited to data overflow, erroneous data input format, cache failure, and/or the like. The Logging module 223 may log activities of the application and write the log information in a file.

The Report Generator module 224 may generate different types of reports that would aid in tracking/evaluating project(s) progress. In one embodiment, the Report Generator module 224 may generate reports based on the data related to reminders, code development entities and tasks. For example, in one implementation, a user may request the Report Generator module 224 to generate a report listing all reminders associated with one specified code development entity. In another embodiment, the reports may be generated based on the reminder(s) status. For example, in one implementation, the Report Generator module 224 may generate a report of active reminders, a report of expired reminders, a report of the reminders' status associated with specific code development entities, a report of reminders associated with a specified user/group, and/or the like. In one embodiment, the reports may be generated/viewed via a R-MANAGER user interface, and may be saved in specified formats (e.g. pdf, html, txt, and/or the like) and emailed to specific users/groups. In another embodiment, a user may configure the R-MANAGER to generate and/or mail the specific types of reports to the configured user(s)/group(s) on a periodical basis, and/or based on certain triggers/events. For example, in one implementation, a user may request a report of reminders associated with a specified code development entity when all the reminders associated with the specified code development entity expire. In one implementation, the Report Generator module 224 may generate reports with charts/graphs such as, but not limited to pie charts, bar charts, statistical graphs, and/or the like.

In one implementation, the R-MANAGER controller 205 may further be coupled to one or more databases configured to store and/or maintain R-MANAGER data. A user database 225 may contain information pertaining to account information, contact information, profile information, identities of hardware devices, Customer Premise Equipments (CPEs), and/or the like associated with users, reminder preferences, reminder configurations, system settings, and/or the like. A hardware database 228 may contain information pertaining to hardware devices with which the R-MANAGER system may communicate, such as but not limited to Email servers, user telephony devices, CPEs, gateways, routers, user terminals, and/or the like. The hardware database 228 may specify transmission protocols, data formats, and/or the like suitable for communicating with hardware devices employed by any of a variety of R-MANAGER affiliated entities. A reminder database 230 may contain data pertaining to reminders and tasks of a project. In one embodiment, the reminder database 230 may maintain a reminder list. The reminder list may include fields such as, but not limited to task description, priority level, related code development entities, reminding methods, responsible personnel, reminder start date, reminder expiration, frequency, and/or the like. In one implementation, the reminder database 230 may also maintain a task review list. The task review list may include fields such as task name, task description, task status, responsible personnel, and/or the like. A difference between the reminder list and the task review list in one implementation may be that a reminder in the reminder list may be deleted when the associated task is completed. However, the associated task may remain in the task review list with updated status for review purposes.

The R-MANAGER database may be implemented using various standard data-structures, such as an array, hash, (linked) list, struct, structured text file (e.g., XML), table, and/or the like. For example, in one embodiment, the XML for the Reminder List in the reminder database 225 may take a form similar to the following example:

```
<Reminder>
    ...
        <ID> MyCode1_0008 </ID>
        <To_Do> Implement load balancing </To_Do>
        <Start_Date> 5/12/2009 11:30:00 </Start_Date>
        <Due_Date> 5/22/2009 15:00:00 </Due_Date>
        <Entity> C:\project\directory1\source_file1.java </Entity>
        <Related_Staff>
              <Staff_1> Smith, Joe </Staff_1>
              <Staff_2> Green, David </Staff_2>
              <Staff_3> White, Ed </Staff_3>
        </Related_Staff>
        <Tagged_Code> /* TODO - Implement load balancing;
        SD [12.05.2009:11h30m00s]; ED [22.05.2009:
        15h00m00s]; FREQ [daily]; P1*/
        if (variable_value==0){...}
        </Tagged_Code>
        <Remind_Freq> daily; 10:00 </Remind_Freq>
        <Remind_Method> Screen Display ; Email
        </Remind_Method>
        <Priority> 1 </Priority>
        <DEPENDENCY>
              <Dependent_from> MyCode1_0007
              </Dependent_from>
        <DEPENDENCY>
              ...
</Reminder>
```

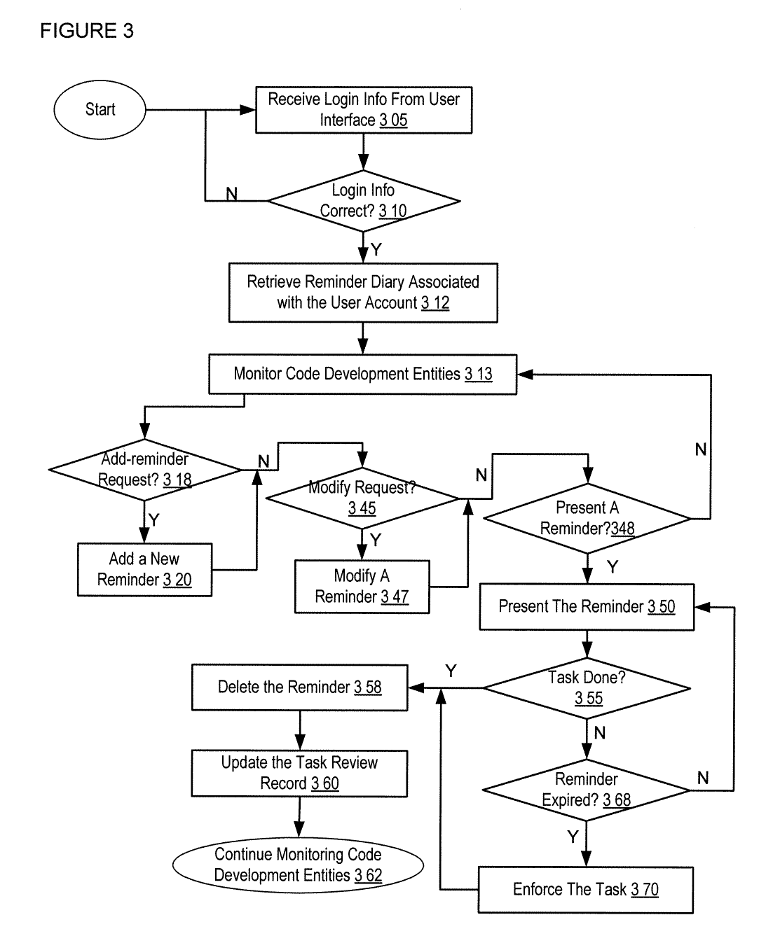

FIG. 3 shows an overview of R-MANAGER logic flows for implementing a R-MANAGER application within one embodiment illustrating aspects of R-MANAGER operation. In one embodiment, the R-MANAGER may be initiated when receiving secured login information 305 through a user interface. If the login information is correct 310, the R-MANAGER may then retrieve the subscribed Reminder Diary associated with the user account 312, and monitor all the code development entities 313 registered with the R-MANAGER. For example, in one embodiment, if a directory “\\repository1\com\server\cache\” is created for a particular project, wherein there are sub-directories for different development files and modules for the project, a user may register the directory “\\repository1\com\server\cache\” with R-MANAGER such that the R-MANAGER would monitor all the files under this directory. In one embodiment, the R-MANAGER may scan files under a directory periodically (e.g. launched via cron), or parse on triggers, such as user interaction with a file/folder (e.g. via OSX folder actions), and/or the like. If there is an add-reminder request 318, the R-MANAGER may proceed to perform the function of adding a new reminder 320, as will be illustrated in FIGS. 4A and 4B. Otherwise, in one embodiment, if the R-MANAGER receives a request for modifying an existing reminder 345, the R-MANAGER may search and modify an existing reminder 347. In one implementation, a user may search existing reminders for specified search criteria, and the R-MANAGER may return the search result to the user. For example, in one implementation, a user may submit a request to search for any reminder associated with a specified code development entity, and the R-MANAGER may form a query based on the user-specified criteria to search the existing reminders and list all the reminders associated with the code development entity on a user interface. In one implementation, a user may modify an existing reminder directly in a tagged segment of code, for example, if the reminder is a within-entity reminder and is directly written in the tagged segment of code. In another implementation, the IDE may provide a list of tasks and reminders to a user and the user may modify a reminder through the IDE provided lists. In a further implementation, the user may also open and edit a reminder via a user interface of the R-MANAGER application.

In one embodiment, if the R-MANAGER further receives a request to present an existing reminder 348, the R-MANAGER may present an existing reminder 350 to the related users in different modes, as discussed with reference to module 218 of FIG. 2. Otherwise, the R-MANAGER may keep monitoring the code development entities.

In one implementation, a user may set filters for the R-MANAGER to search for a selected set of reminders and be notified when the selected set of reminders are newly added and/or expired. In one implementation, the R-MANAGER may also include a tagged segment of code in a reminder message sent to the user. In order to implement and present an existing reminder, the R-MANAGER may determine whether the task associated with the reminder has been completed 355. If the task has already been marked as completed, the R-MANAGER may automatically delete the reminder 358 from the reminder list. In one implementation, the R-MANAGER may delete an existing reminder if a request of intentional abandonment is received from a user. In one implementation, the R-MANAGER may further update the status of the task in the task review record accordingly 360, as “accomplished” or “abandoned”. In one embodiment, at 355, if the task has not been marked as completed, the R-MANAGER may further determine whether the reminder has expired 368. If the reminder has not expired, the R-MANAGER may keep presenting the reminder to related users 350 until the expiration date has arrived. However, if the reminder has elapsed, the R-MANAGER may proceed to perform the function of enforcing the task associated with the reminder 370, as will be illustrated in one implementation in FIG. 4C. After the task enforcement 370, the reminder may be marked as completed, whereby the associated task is either accomplished as planned or intentionally abandoned. In either case, the reminder may be deleted 358 from the R-MANAGER and the task information may be updated accordingly 360.

In one implementation, the R-MANAGER may be configured to generate project review reports based on the R-MANAGER data. For example, in one embodiment, the users (e.g. developers, code reviewers, testing developers, management staff, etc.) may seek to obtain and review project review reports periodically during the development for a variety of purposes, such as, but not limited to evaluating project progress, evaluating personnel performance, and/or the like. In one implementation, the project review reports may be automatically generated on a periodical basis, or based on user requests, and optionally emailed to the user(s).

FIGS. 4A and 4B illustrate aspects of logic flows for adding a new reminder 320 in one embodiment of R-MANAGER operation. In one embodiment, a new reminder may be added to the R-MANAGER in different ways, as illustrated in FIGS. 4A and 4B, respectively. In one embodiment, as of FIG. 4A, the R-MANAGER may add a new reminder by scanning code development entities 421 and detecting a reminder embedded in a tagged segment of source code 422. To detect an embedded reminder, for example, in one implementation, files may be searched using a “grep” command line using predetermined syntax as keywords (e.g. “TO DO”, “SD”, “FREQ”, etc.) under a UNIX platform, and texts following such predetermined keywords but preceding an end-of-reminder syntax are recognized and extracted as contents of the indicated reminder. In another implementation, programs such as Lex&Yacc may be used to generate a parser for a predetermined syntax and extract the tokens. When a reminder is detected, the R-MANAGER may first determine whether the reminder is unprecedentedly found 423. If the detected reminder is new, the R-MANAGER may extract the embedded information and generate a new reminder 425. Otherwise, the R-MANAGER may return to 421 and keep scanning code development entities for new reminders. When a new reminder is to be added to the reminder list through the Reminder Diary, the R-MANAGER may then determine whether the reminder already exists 430. If the reminder does not exist, the R-MANAGER may then update the Reminder Diary with the new reminder 437. For example, in one implementation, the Reminder Diary may form a query in the stored reminder list in the database searching for a reminder identical to the new reminder. If no match is returned from such queries, the Reminder Diary may form a reminder record and update revised fields according to the new reminder, and the record is then stored in the reminder database. Otherwise, if the reminder already exists in the system, the R-MANAGER may continue monitoring and scanning code development entities.

In one embodiment, as of FIG. 4B, the R-MANAGER may receive a request of adding a new reminder with a user submitting a new reminder via a R-MANAGER user interface 427. In one embodiment, the R-MANAGER may present a graphic user interface (e.g. a message box) for the user to fill in required information and generate a new reminder. In another embodiment, the R-MANAGER may be interfaced with a command-line tool (e.g. a GNU/Linux command-line tool, etc.) and receive a command line to add a new reminder. The R-MANAGER may then determine whether the submitted new reminder is a for-entity reminder 429, or a within-entity reminder, i.e. whether the new reminder points to the entirety of a code development entity, or a tagged segment of code. If the newly submitted reminder is a within-entity reminder, the R-MANAGER may scan a group of code development entities to locate the tagged code segment associated with the newly submitted reminder 433, and attach the location of the tagged code to the new reminder 435, for example, a link pointing to the line of the tagged code and the associated source file. If the newly submitted reminder is a for-entity reminder, the R-MANAGER may also determine to scan the code development entities. For example, a reminder may request a user review a text file and add a “read entire file” indication in a tagged segment of source code. In one implementation, the R-MANAGER may then determine whether the reminder already exists 430. If the reminder does not exist, the R-MANAGER may then update the Reminder Diary with the new reminder 437. Otherwise, if the reminder already exists in the system, the R-MANAGER may continue with 313.

FIG. 4C illustrates aspects of enforcing a task 370 in one embodiment of R-MANAGER operation. When an existing reminder has expired but the associated task has not been marked as completed, the R-MANAGER may display or send warning messages to the related users 471. For example, the warning messages may be sent in different modes similar to modes of reminding messages, which may be predetermined and/or modified by a user through system configuration settings. The R-MANAGER may further determine whether the reminder is marked as completed. if not, the R-MANAGER may take further action to send an indication to the IDE to lock the related code development entity 475, for example, in one implementation, to reject commitment and/or submission of the code development entity 477. In another implementation, the R-MANAGER may be implemented to notify not only the IDE, but also the Version Control System/Source Code Management System associated with the code (e.g. CVS, Subversion, and/or the like) in order to enforce task completion. For example, the Version Control System, which controls the code development versions, may reject commitment and/or submission of the code development entity.

In one embodiment, the R-MANAGER may reject commitment and/or submission of all code development entities that have reminders dependent from the reminder at 473. For example, in one implementation, if a reminder “Add exception handlers” is not completed and its dependency is set such that all files in the project are dependent from the reminder, the R-MANAGER may reject commitment and/or submission of all files in the project even if other files may have all tasks marked as complete.

The R-MANAGER may determine whether the task has been completed again at 480. If still not marked as completed, the R-MANAGER may report to team management 482 to ensure task completion is enforced offline 483 such as by the team management. For example, the team management may decide whether to proceed and accomplish the task, or to abandon the task intentionally. In one implementation, if the reminder is marked as “completed”, for example, at 473 and 480, the R-MANAGER may continue with 358.

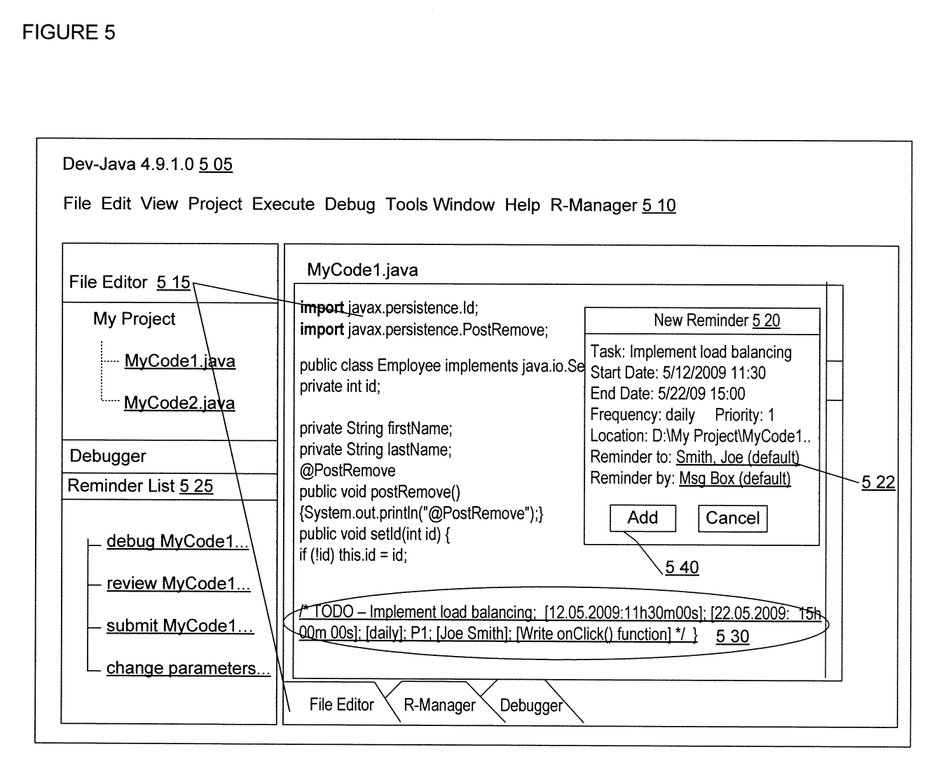

FIG. 5 provides a schematic example of an implementation of a user interface illustrating aspects of R-MANAGER operation. In FIG. 5, an exemplary schematic user interface of the reminder manager embedded within a Java IDE is shown. In one embodiment, the tool bar of the Dev-Java 4.9.1.0 window 505 may contain a R-MANAGER icon, menu and/or the like, 510. The IDE window 505 may also present a reminder list 525 as indicated, in the left bottom area, generated based on the tasks associated with the reminder list of the R-MANAGER. A user may click any item in the reminder list 525 to review and modify a reminder. In the file editor 515 of the IDE, a reminder may be embedded in a tagged segment of code 530. When the R-MANAGER has detected the embedded reminder 530, the R-MANAGER may highlight the embedded reminder 530 in the file editor, and a new reminder window 520 may automatically pop up with extracted information. In one implementation, a user working under his/her own account to add the new reminder may be automatically identified as the person to be reminded by default. For example, in the new reminder window 520, if developer Joe Smith has logged into the system and added the reminder 530 in the source file “MyCode1.java”, the R-MANAGER may automatically put “Smith, Joe” in the “Reminder to” entry by default 522. In one embodiment, the user may modify default values manually. After a user has reviewed all the information in the new reminder 520, the user may click “add” button 540 and add the new reminder to the reminder list of the R-MANAGER. A new item showing the task “Implement load balancing” may also be added to the reminder list 525.

In one embodiment, in a drag-and-drop environment (e.g. Microsoft Visual Basic, etc.), the R-MANAGER may be implemented as a plug-in feature of the drag-and-drop environment. For example, in one implementation, a menu including R-MANAGER operations, such as “add a reminder”, “modify a reminder”, and/or the like, may be activated and presented on screen if a user right-clicks on a drag-and-drop component.

### R-MANAGER Controller

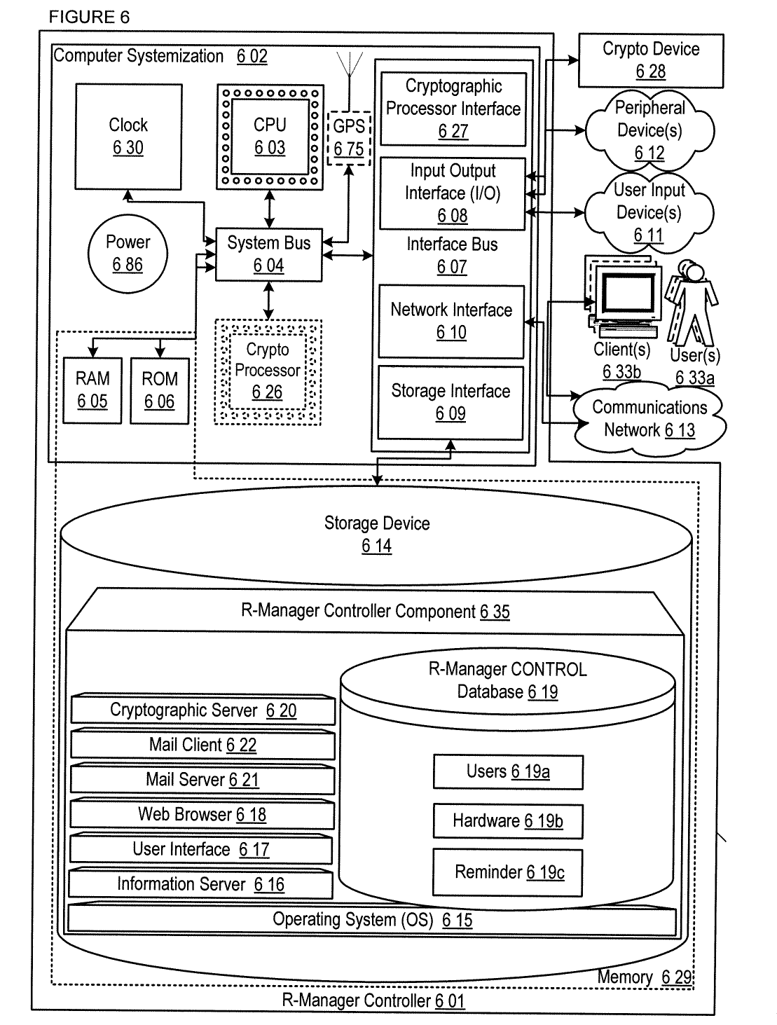

FIG. 6 of the present disclosure illustrates inventive aspects of a R-MANAGER controller 601 in a block diagram.

Typically, users, which may be people and/or other systems, engage information technology systems (e.g., commonly computers) to facilitate information processing. In turn, computers employ processors to process information; such processors are often referred to as central processing units (CPUs). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the R-MANAGER controller 601 may be connected to and/or communicate with entities such as, but not limited to: one or more users from user input devices 611; peripheral devices 612; a cryptographic processor device 628; and/or a communications network 613.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The R-MANAGER controller 601 may be based on common computer systems that may comprise, but are not limited to, components such as: a computer systemization 602 connected to memory 629.

Computer Systemization

A computer systemization 602 may comprise a clock 630, central processing unit (CPU) 603, a read only memory (ROM) 606, a random access memory (RAM) 605, and/or an interface bus 607, and most frequently, although not necessarily, the foregoing are all interconnected and/or communicating through a system bus 604. Optionally, the computer systemization may be connected to an internal power source 686. Optionally, a cryptographic processor 626 and/or a global positioning system (GPS) component 675 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the R-MANAGER controller and beyond through various interfaces. Should processing requirements dictate a greater amount of speed, parallel, mainframe and/or super-computer architectures may similarly be employed. Alternatively, should deployment requirements dictate greater portability, smaller Personal Digital Assistants (PDAs) may be employed.

Power Source

The power source 686 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 686 is connected to at least one of the interconnected subsequent components of the R-MANAGER thereby providing an electric current to all subsequent components. In one example, the power source 686 is connected to the system bus component 604. In an alternative embodiment, an outside power source 686 is provided through a connection across the I/O 608 interface. For example, a USB and/or IEEE 1394 connection carries both data and power across the connection and is therefore a suitable source of power.

Interface Adapters

Interface bus(es) 607 may accept, connect, and/or communicate to a number of interface adapters, conventionally although not necessarily in the form of adapter cards, such as, but not limited to: input output interfaces (I/O) 608, storage interfaces 609, network interfaces 610, and/or the like. Optionally, cryptographic processor interfaces 627 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 609 may accept, communicate, and/or connect to a number of storage devices such as, but not limited to: storage devices 614, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 610 may accept, communicate, and/or connect to a communications network 613. Through a communications network 613, the R-MANAGER controller is accessible through remote clients 633b (e.g., computers with web browsers) by users 633a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 610 may be used to engage with various communications network types 613. For example, multiple network interfaces may be employed to allow for the communication over broadcast, multicast, and/or unicast networks.

Input Output interfaces (I/O) 608 may accept, communicate, and/or connect to user input devices 611, peripheral devices 612, cryptographic processor devices 628, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 611 may be card readers, dongles, finger print readers, gloves, graphics tablets, joysticks, keyboards, mouse (mice), remote controls, retina readers, trackballs, trackpads, and/or the like.

Peripheral devices 612 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the R-MANAGER controller may be embodied as an embedded, dedicated, and/or monitor-less (i.e., headless) device, wherein access would be provided over a network interface connection.

Cryptographic units such as, but not limited to, microcontrollers, crypto processors 626, interfaces 627, and/or devices 628 may be attached, and/or communicate with the R-MANAGER controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allow for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 629. However, memory is a fungible technology and resource; thus, any number of memory embodiments may be employed in lieu of or in concert with one another. It is to be understood that the R-MANAGER controller and/or a computer systemization may employ various forms of memory 629. For example, a computer systemization may be configured wherein the functionality of on-chip CPU memory (e.g., registers), RAM, ROM, and any other storage devices are provided by a paper punch tape or paper punch card mechanism; of course, such an embodiment would result in an extremely slow rate of operation. In a typical configuration, memory 629 will include ROM 606, RAM 605, and a storage device 614. A storage device 614 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

Component Collection

The memory 629 may contain a collection of program and/or database components and/or data such as, but not limited to: operating system component(s) 615 (operating system); information server component(s) 616 (information server); user interface component(s) 617 (user interface); Web browser component(s) 618 (Web browser); database(s) 619; mail server component(s) 621; mail client component(s) 622; cryptographic server component(s) 620 (cryptographic server); the R-MANAGER component(s) 635; and/or the like (i.e., collectively a component collection). These components may be stored and accessed from the storage devices and/or from storage devices accessible through an interface bus. Although non-conventional program components such as those in the component collection, typically, are stored in a local storage device 614, they may also be loaded and/or stored in memory such as: peripheral devices, RAM, remote storage facilities through a communications network, ROM, various forms of memory, and/or the like.

Operating System

The operating system component 615 is an executable program component facilitating the operation of the R-MANAGER controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the R-MANAGER controller to communicate with other entities through a communications network 613. Various communication protocols may be used by the R-MANAGER controller as a subcarrier transport mechanism for interaction, such as, but not limited to: multicast, TCP/IP, UDP, unicast, and/or the like.

Information Server

An information server component 616 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, Java, JavaScript, Practical Extraction Report Language (PERL), Hypertext Pre-Processor (PHP), pipes, Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the R-MANAGER controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the R-MANAGER database 619, operating systems, other program components, user interfaces, Web browsers, and/or the like.

Access to the R-MANAGER database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the R-MANAGER. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the R-MANAGER as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/Vista (i.e., Aero)/XP, or Unix's X-Windows (e.g., which may include additional Unix graphic interface libraries and layers such as K Desktop Environment (KDE), mythTV and GNU Network Object Model Environment (GNOME)), provide a baseline and means of accessing and displaying information graphically to users.

A user interface component 617 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact with, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 618 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in entity of a Web browser and information server, a combined application may be developed to perform similar functions of both. The combined application would similarly affect the obtaining and the provision of information to users, user agents, and/or the like from the R-MANAGER enabled nodes. The combined application may be nugatory on systems employing standard Web browsers.

Mail Server

A mail server component 621 is a stored program component that is executed by a CPU 603. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the R-MANAGER.

Access to the R-MANAGER mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 622 is a stored program component that is executed by a CPU 603. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 620 is a stored program component that is executed by a CPU 603, cryptographic processor 626, cryptographic processor interface 627, cryptographic processor device 628, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the R-MANAGER may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the R-MANAGER component to engage in secure transactions if so desired. The cryptographic component facilitates the secure accessing of resources on the R-MANAGER and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The R-MANAGER Database

The R-MANAGER database component 619 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the R-MANAGER database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data, but may have other types of functionality encapsulated within a given object. If the R-MANAGER database is implemented as a data-structure, the use of the R-MANAGER database 619 may be integrated into another component such as the R-MANAGER component 635. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 619 includes several tables 619a-c. A Users table 619a may include fields such as, but not limited to: user_ID, user_name, user_password, contact_info, hardware_ID, task_ID, task_history, user_evaluation and/or the like. A Hardware table 619b may include fields such as, but not limited to: hardware_ID, hardware_type, hardware_name, data_formatting requirements, protocols, addressing_info, usage_history, hardware_requirements, user_ID, and/or the like. A reminder table 619c may include fields such as, but not limited to: task_ID, task_description, priority_level, related_entities, reminding_methods, responsible_personnel, user_ID, start_date, end_date, reminding_frequency, and/or the like. These tables may support and/or track multiple entity accounts on the R-MANAGER controller.

In one embodiment, the R-MANAGER database may interact with other database systems. For example, the R-MANAGER may employ a distributed database system for queries and data access by search. In one implementation, the R-MANAGER component may treat the combination of the R-MANAGER database and an integrated data security layer database as a single database entity.

In one embodiment, user programs may contain various user interface primitives, which may serve to update the R-MANAGER. Also, various accounts may require custom database tables depending upon the environments and the types of clients the R-MANAGER may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 619a-c. The R-MANAGER may be configured to keep track of various settings, inputs, and parameters via database controllers.

The R-MANAGER database may communicate to and/or with other components in a component collection, including itself, and/or facilities of the like. Most frequently, the R-MANAGER database communicates with the R-MANAGER component, other program components, and/or the like. The database may contain, retain, and provide information regarding other nodes and data.

The R-MANAGER Component

The R-MANAGER component 635 is a stored program component that is executed by a CPU. In one embodiment, the R-MANAGER component incorporates any and/or all combinations of the aspects of the R-MANAGER that was discussed in the previous figures. As such, the R-MANAGER affects accessing, obtaining and the provision of information, services, transactions, and/or the like across various communications networks.

The R-MANAGER component is configurable to access, calculate, engage, exchange, generate, identify, instruct, match, process, search, serve, store, and/or facilitate communication channels between R-MANAGER components and/or affiliated entities, transmission of reminders between interfaces, functional modules and storage elements, and/or the like and use of the R-MANAGER.

The R-MANAGER component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, WebObjects, and/or the like. In one embodiment, the R-MANAGER server employs a cryptographic server to encrypt and decrypt communications. The R-MANAGER component may communicate to and/or with other components in a component collection, including itself, and/or facilities of the like. Most frequently, the R-MANAGER component communicates with the R-MANAGER database, operating systems, other program components, and/or the like. The R-MANAGER may contain, communicate, generate, obtain, and/or provide program component, system, user, and/or data communications, requests, and/or responses.

Distributed R-MANAGER

The structure and/or operation of any of the R-MANAGER node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the R-MANAGER controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A processor-enabled method, comprising:
receiving a request to add a new reminder of a task to a reminder list;
associating at least one code development entity to the new reminder;
adding the new reminder of the task associated with the at least one code development entity to the reminder list;
presenting an existing reminder in the reminder list to at least one user; and
enforcing at least one user to complete a task recorded by an existing reminder if the existing reminder of the task has expired.

2. The method of claim 1, wherein receiving a request to add a new reminder of a task to a reminder list comprises at least one of:
receiving an indication to add a new reminder from a user interface action;
locating a new reminder embedded in a tagged segment of code in a code development entity by scanning a plurality of code development entities.

3. The method of claim 2, wherein the embedded reminder in the tagged segment of code in a code development entity is written in compliance with a predetermined syntax,
wherein the predetermined syntax is configurable by an authorized user.

4. The method of claim 1, wherein the at least one code development entity comprises at least one of:
at least one code development file;
at least one file directory;
at least one project portfolio; and
at least one group of code development files specified by a user.

5. The method of claim 1, wherein associating at least one code development entity to the new reminder comprises at least one of:
recording at least a name of the at least one code development entity in the new reminder;
generating and recording a link in the new reminder pointing to the at least one code development entity; and
generating and recording a first link in the new reminder pointing to the at least one code development entity and a second link pointing to a tagged segment of code within the at least one code development entity.

6. The method of claim 1, wherein adding the new reminder of the task associated with the at least one code development entity to the reminder list comprises at least one of:
adding a new reminder to the reminder list if the new reminder is submitted by a user interface action; and
extracting information written in a tagged segment of code if the tagged segment of code indicate a new reminder,
generating a new reminder based on the extracted information, and
adding the new reminder to the reminder list.

7. The method of claim 1, wherein the reminder comprises at least one of:
at least one task;
a location of at least one associated code development entity;
at least one user to be reminded;
at least one schedule to present the reminder;
inter-correlated reminders and tasks; and
at least one method to present the reminder.

8. The method of claim 6, wherein a location of at least one associated code development entity comprises at least one of:
a link pointing to a code development file;
a link pointing to a directory of code development files;
a link pointing to a code development project portfolio; and
a first link pointing to a code development file and a second link pointing to a tagged segment of source code within the code development file;

9. The method of claim 1 further comprises modifying an existing reminder in the reminder list, wherein modifying an existing reminder comprises at least one of:
directly editing reminder information in a tagged segment of code wherein the tagged segment of code is associated with the existing reminder;
modifying the existing reminder through a reminder list displayed as part of a code integrated development environment (IDE); and
modifying the existing reminder through a reminder list displayed on an exclusive user interface wherein the exclusive user interface is not part of an IDE.

10. The method of claim 1 further comprises registering a plurality of code development entities and monitoring the registered plurality of code development entities.

11. The method of claim 1 further comprises deleting an existing reminder from the reminder list.

12. The method of claim 11, wherein deleting an existing reminder from the reminder list comprises:
automatically removing an existing reminder from the reminder list if the existing reminder has been completed; and
removing an existing reminder from the reminder list if receiving a request from at least one authorized user to delete the existing reminder.

13. The method of claim 1, wherein presenting a reminder to at least one user comprises at least one of the following modes:
displaying a message window via a user interface to the at least one user;
sending an email to at least one email account associated with the at least one user;
sending a message via a real-time online chat platform to at least one account associated with the at least one user;
sending a short message to at least one mobile device associated with the at least one user; and
opening a code development file associated with the reminder, and if the reminder is embedded in a segment of source code, highlighting the segment of source code.

14. The method of claim 1, wherein enforcing at least one user to complete a task recorded by an existing reminder comprises at least one of:
constantly displaying warning messages on a screen to the at least one user;
sending email alerts to the at least one user;
sending alert short messages to the at least one user;
sending an indication to an integrated development environment (IDE) to reject submission of at least one code development entity associated with the existing reminder; and
reporting to team management.

15. The method of claim 14, wherein the task recorded by the existing reminder is completed if at least one of the following happens:
the task recorded by the reminder is accomplished; and
the task recorded by the existing reminder is intentionally abandoned by at least one authorized user.

16. The method of claim 1, further comprises:
allowing multiple users to login and access the same code development entity; and
subscribing a user to a plurality of reminders in the reminder list which are associated with the user.

17. The method of claim 1, further comprises executing a daemon application.

18. The method of claim 1, wherein the daemon application, comprises: (i) a reminder diary module; (ii) a validator module; (iii) a notifier module; (iv) a reader module; (v) an authentication module; (vi) an exception handler module; and (vii) a logging module.

19. An apparatus, comprising:
a processor;
a memory in communication with the processor and containing program instructions;
an input and output device in communication with the processor and memory comprising a graphical interface;
wherein the processor executes program instructions contained in the memory and the program instructions comprise:
receive a request to add a new reminder of a task to a reminder list;
associate at least one code development entity to the new reminder;
add the new reminder of the task associated with the at least one code development entity to the reminder list; and
present an existing reminder in the reminder list to at least one user; and
enforce at least one user to complete a task recorded by an existing reminder if the existing reminder of the task has expired.

20. A processor readable medium, comprising:
processor readable instructions stored in the processor readable medium, wherein the processor readable instructions are issuable by a processor to:
receive a request to add a new reminder of a task to a reminder list;
associate at least one code development entity to the new reminder;
add the new reminder of the task associated with the at least one code development entity to the reminder list; and
present an existing reminder in the reminder list to at least one user; and
enforce at least one user to complete a task recorded by an existing reminder if the existing reminder of the task has expired.
